(19) United States
(12) Patent Application Publication
(10) Pub. No.: US 2018/0065780 A1
(43) Pub. Date: Mar. 8, 2018

(54) CASE WITH INTERNAL GRAPHIC

(71) Applicant: Samsonite IP Holdings S.àr.l., Lexembourg (LU)

(72) Inventors: Randy Yang CHIANG, San Francisco, CA (US); Bryan Lee Hynecek, Redwood City, CA (US); Roxana Janet Ghani Dietrich, San Francisco, CA (US); Iris Karman Kwan Yu, San Bruno, CA (US)

(73) Assignee: Samsonite IP Holdings S.àr.l., Lexembourg (LU)

(21) Appl. No.: 15/257,304

(22) Filed: Sep. 6, 2016

(51) Int. Cl. B65D 25/20; A45C 13/00; A45C 11/00; A45F 5/00; B65D 25/54; B29C 65/48; B29C 65/70

(52) U.S. Cl. CPC B65D 25/205; A45C 13/002; A45C 11/00; A45F 5/00; B29L 2031/712; B29C 65/48; B29C 65/70; A45C 2011/002; A45C 2011/001; B65D 25/54

(57) ABSTRACT

A case for a mobile device, including a first layer, a second layer, and a first graphic. The second layer is arranged to be located closer to the mobile device than the first layer when the mobile device is arranged within the case. The first graphic is located between the first layer and the second layer. In addition, a first portion of at least one layer, of the first and second layers, corresponding to a location of the first graphic within the case, is translucent, transparent, or clear.

### FIELD OF THE INVENTION

The present invention relates to a multi-layer case for a mobile device. The case includes a graphic that is located between two of the layers of the case.

Cases for mobile devices have been designed to provide at least some protection from impact events, such as when the device is dropped, hit, or otherwise struck. It may be desirable to include a graphic on the case.

Such a graphic can be arranged on the outside of the case. But such a configuration presents the situation where the graphic may be degraded or scratched from constant handling of the device when arranged in the case, from a dropping incident where the outside of the case is abraded by an object or surface (e.g., pavement or the like), or from any other situation where the outside of the case, and thus the graphic, is contacted by another object.

The graphic can also be arranged on the inside of the case. But a graphic in such a location may be degraded or scratched from putting the mobile device into the case or taking the mobile device out of the case. The graphic can also be degraded or scratched if foreign matter gets between the case and the mobile device (e.g., sand when taking the protected device to a beach, or any other granular matter and the like).

### SUMMARY OF THE INVENTION

As such, it is desirable to provide a new mobile-device case, which has a graphic that is protected from being scratched or otherwise degraded.

According to the present invention there is therefore provided a case for a mobile device as described by way of example below and in the accompanying claims.

In one embodiment of the invention there is provided a case for a mobile device, including a first layer, a second layer, and a first graphic. The second layer is arranged to be located closer to the mobile device than the first layer when the mobile device is arranged within the case. The first graphic is located between the first layer and the second layer. In addition, a first portion of at least one layer, of the first and second layers, corresponding to a location of the first graphic within the case, is translucent, transparent, or clear.

In another embodiment, the first portion is a portion of the first layer.

In yet another embodiment, the first portion is a portion of the second layer.

In a further embodiment, first portions of both the first and second layers, each first portion corresponding to a location of the first graphic within the case, are translucent, transparent, or clear,

In yet a further embodiment, each first portion is translucent.

In another embodiment, each first portion is transparent.

In yet another embodiment, each first portion is clear.

In a further embodiment, each first portion has a visible light transmittance (VLT) of at least 20%.

In yet a further embodiment, each first portion has a visible light transmittance (VLT) of at least 50%.

In another embodiment, each first portion has a visible light transmittance (VLT) of at least 80%.

In yet another embodiment, each first portion has a visible light transmittance (VLT) of at least 90%.

In a further embodiment, each first portion has a visible light transmittance (VLT) of 100%.

In yet a further embodiment, the first layer and the second layer are permanently affixed to each other.

In yet a further embodiment, the first layer mechanically engages with the second layer so as to be separable therefrom.

In another embodiment, the first layer comprises a rigid material, and the second layer comprises an elastomeric material.

In yet another embodiment, first layer forms a recess in which at least a part of the second layer is arranged, the recess being further configured to hold the mobile device.

In a further embodiment, the second layer includes a pocket configured to hold the mobile device.

In another embodiment, the first graphic is permanently affixed to an inside surface of the first layer, which inside surface faces toward the mobile device when the mobile device is arranged in the case.

In yet another embodiment, the case includes a second graphic that is permanently affixed to an outside surface of the second layer, which outside surface faces away from the mobile device when the mobile device is arranged in the case.

In a further embodiment, the first graphic is permanently affixed to an outside surface of the second layer, which outside surface faces away from the mobile device when the mobile device is arranged in the case.

In a further embodiment, a method of forming a case for a mobile device is provided. The method includes molding a first layer, and printing a first graphic on the first layer. The method also includes molding a second layer, and joining the first layer and the second layer together so that the first graphic is located between the first and second layers.

In yet a further embodiment, the second layer is molded separately from, and before, after, or simultaneously with, the first layer.

In another embodiment, the method further includes printing a second graphic on the second layer before the first and second layers are joined together. The first layer and the second layer are joined together so that both the first graphic and the second graphic are located between the first and second layers.

In yet another embodiment, the first and second layers are joined together so that the first layer mechanically engages with the second layer so as to be separable therefrom.

In a further embodiment, the first graphic is printed on an inside surface of the first layer, which inside surface faces toward the mobile device when the mobile device is arranged in the case. In addition, molding the second layer, and joining the first layer and the second layer, jointly include placing the first layer into an overmold tool, and molding the second layer onto the inner surface of the first layer so as to cover the printed graphic and join the second layer to the first layer.

In yet a further embodiment, the first layer comprises a rigid material, and the second layer comprises an elastomeric material.

In another embodiment, the first graphic is printed on an outside surface of the first layer, which outside surface faces away from the mobile device when the mobile device is arranged in the case. Also, molding the second layer, and joining the first layer and the second layer, jointly include placing the first layer into an overmold tool, and molding the second layer onto the outside surface of the first layer so as to cover the printed graphic and join the second layer to the first layer.

In yet another embodiment, a first portion of at least one layer, of the first and second layers, corresponding to a location of the first graphic within the case, is translucent, transparent, or clear.

In a further embodiment, the first portion is a portion of the first layer.

In yet a further embodiment, the first portion is a portion of the second layer.

In another embodiment, first portions of both the first and second layers, each first portion corresponding to a location of the first graphic within the case, are translucent, transparent, or clear.

It is noted that the features of the above-described embodiments are not exclusive to each other, and that any one of the above embodiments/features can be combined with one or more of the other embodiments/features to arrive at further embodiments.

The inventive case can be designed to fit a variety of mobile devices—such as smartphones and other portable electronic devices.

### BRIEF DESCRIPTION OF THE DRAWINGS

FIG. 1 shows an expanded view of a case 1 according to an embodiment of the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments. It is noted that any numerical ranges disclosed herein are included to individually disclose every sub-range and number, both whole integer and partial fraction, within the disclosed range. For example, a disclosed range of 1-100 is intended to individually disclose 20-90, 40-80, 30.5-50.2, 20, 67.3, 84.512924, and every other range and number that falls within the recited range.

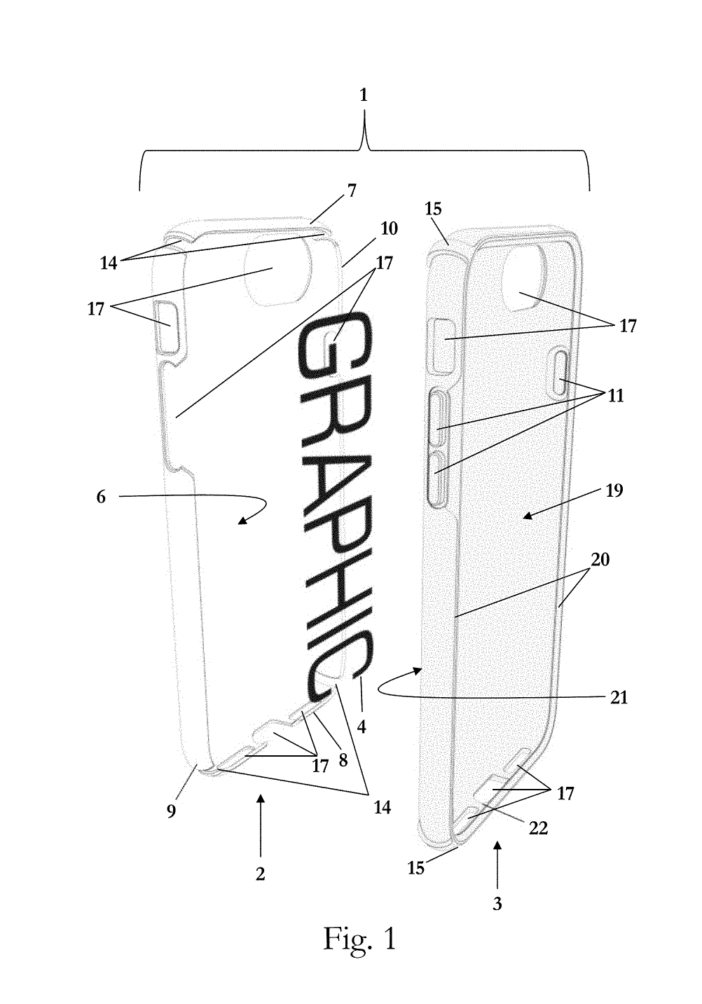

FIG. 1 shows an expanded view of a case 1 according to an embodiment of the invention. The case 1 includes a first layer or shell 2, a second layer 3, and a graphic 4 which is located between and sandwiched by the first layer 2 and the second layer 3. The first layer or shell 2 includes a rear side having an inside surface 6 and an outside surface (not shown) opposite to the inside surface. A far side 7, a near side 8, a left side 9, and a right side 10 extend from the inside surface 6 of the rear side toward a front of the case 1 so as to form a pocket or recess in which the second layer 3 will be—and eventually a mobile device can be—arranged. The second layer 3 also includes a corresponding rear side having a rear surface 21, as well as one or more of corresponding far, near (22), left, and right sides. A pocket or recess 19 may be formed in second layer 3 for receiving the mobile device.

The rear sides of the first layer 2 and second layer 3 overlay each other. The rear sides of the first layer or shell 2 and second layer 3 are also preferably substantially coextensive with each other so that the rear side of each layer covers at least 50% of the surface area of the rear side of the other layer. It is also preferable that the respective far sides, near sides, left sides, and right sides of the first layer 2 and second layer 3 are substantially coextensive with each other so that the respective far sides, near sides, left sides, and right sides of each layer covers at least 50% of the surface area of the corresponding side of the other layer. Additionally, it is preferable that the rear of the case (formed by the rear sides of the first layer 2 and second layer 3) is configured to cover at least 90%, if not all, of the rear of a mobile device when the mobile device is arranged within the case.

The first layer or shell 2 is preferably formed from a rigid or hard material to create a rigid outer shell which provides at least some impact protection from impacts with sharp objects. Examples of suitable rigid materials include hardened plastic material, a rigid or semi-rigid plastic material, a rigid rubber material, a polycarbonate material, metals, alloys, a para-aramid material, wood, glass, mirror, quartz, and any combination thereof, and may be any color or texture. Preferred materials include thermosetting plastics with a hard durometer having shore 30D to shore 100D, polycarbonate, metals, acrylonitrile butadiene styrene (“ABS”), PMMA, polyethylene terephthalate (“PET”), high durometer thermoplastic elastomers (“TPEs”) and thermoplastic polyurethanes (“TPUs”) having shore 30D to shore 100D, and any combination thereof. The hard protective exterior shell may be designed to mimic the finish of existing mobile devices, such as phones, MP3/4 players, and other mobile electronic devices. Many users like the feel of the original phone and would like to maintain that feel but still want protection for their device. The hard protective exterior shell of the present invention has a low coefficient of friction. This allows the device to be slipped in and out of pockets easily with little resistance and without becoming attached to clothing materials—a major complaint from users when an elastomeric material is used for the outside of cases.

The second layer 3 is preferably formed from a soft elastomeric material which provides at least some shock protection from impact events such as drops or falls. Examples of suitable materials include thermoplastic elastomers (“TPEs”), thermoplastic polyurethane (“TPU”), silicone, rubber, and any combination therof. The second layer 3 may also be designed so that there are no gaps between the mobile device and the case. This enables the case to have a very solid connection to the phone. The second layer 3 may additionally be formed with a lip or rim 20 so as to secure and retain the mobile device within the case 1. The elastomeric layer 3 also can be formed to have portions 11 designed to cover buttons on a mobile device. This allow a user to simply press the exposed portion 11 of the inner elastomeric layer 3 corresponding to the desired input of the mobile device.

Each of the first layer 2 and second layer 3 is 0.5-4.0 mm thick. Preferably one or more of the layers is 0.6-3.0 mm thick. More preferably, one or more of the layers is 0.8-2.0 mm thick. Even more preferably, one or more of the layers is 0.9-1.3 mm thick.

The first layer 2 and second layer 3 may be co-molded/co-casted together or otherwise permanently affixed to each other, such as with an adhesive, with the graphic 4 sandwiched between the layers.

Alternatively, the first layer 2 and second layer 3 may be separable from one another as two distinct pieces, such as is shown in the exploded FIG. 1. In such an instance, the two layers can be configured so that they mechanically engage with each other to form a unitary case. For example, the first layer 2 may be designed with slots or cutouts 14 into which corresponding ridges or ribs 15 of the second layer 3 engage (e.g., by snapping, pressure fitting, or any other suitable mechanical engagement), with the graphic 4 being sandwiched between the first layer or shell 2 and second layer 3. As another example opposite sides of the first layer 2 (e.g., far side 7 and near side 8, left side 9 and right side 10, or both) may be designed to snap onto and hold the second layer 3.

It is noted that additional openings or cutouts 17 may be provided in at least a part of the case 1 so as to allow various buttons, ports, or features of a protected mobile device to be accessed without having to remove the mobile device from the case 1. For example openings or cutouts 17 may be provided to allow a user to engage a button of the protected mobile device either directly or via the cover portion 11 of the layer 3. As another example, cutouts 17 may be provided to create an opening in the case 1 though which a charging port, audio port, data port, or other electrical port of the mobile device may be accessed, either directly or via a pass-through connection. As yet another example, cutouts 17 may be provided to create an opening to expose a camera lens, audio speaker, microphone, or other feature of the device to be accessed or employed without removing the mobile device from the case 1.

The graphic 4 is applied to the two-layer case 1 in such a way that the graphic is located on one of the mating surfaces of the two layers. For example, the graphic 4 may be applied to the inside surface 6 of the rear side of the first layer 2. As another example, the graphic 4 may be applied to the rear surface 21 of the rear side of the second layer 3. As yet another example, two or more graphics 4 may be applied so that at least one graphic 4 is located on (applied to) the inside surface 6 of the rear side of the first layer 2, and at least one other graphic 4 is located on (applied to) the rear surface 21 of the rear side of the second layer 3.

Thus the graphic 4 is trapped between the two layers 2, 3 in such a way that the graphic 4 cannot be damaged or abraded from the inside case surface or the outside case surface. The graphic may be applied by screen printing, pad printing, sublimation printing, direct digital printing, or any other like printing process, and may include multiple print passes.

For example, one process for application may be:
1. Mold the first layer 2;
2. Print graphic 4 on the inside surface 6 (the bonding surface) of the first layer 2; and
3. Place the first layer 2 into the overmold tool, and mold the second layer 3 onto the first layer 2 (covering the printed graphic).

Another example of a process for application may be:
1. Mold the second layer 3;
2. Print graphic 4 on the rear surface 21 (the bonding surface) of the second layer 3; and
3. Place the second layer 3 into the overmold tool, and mold the first layer 2 onto the second layer 3 (covering the printed graphic).

Yet another example of a process for application may be:
1. Mold the first layer 2;
2. Mold the second layer 3 (separately from, and before, after, or simultaneously with, the first layer 2);
3. Print at least one graphic 4 on the inside surface 6 (the bonding surface) of the first layer 2, the rear surface 21 (the bonding surface) of the second layer 3, or both; and
4. Join together the first layer 2 and the second layer 3.

Examples of graphics 4 include, but are not limited to, drawings (animals, buildings, icons, trademarks), photographs, letters, numbers, words, images, renderings, and the like. The graphics may be in color or gray scale. At least a portion of one of the first layer 2 and the second layer 3, corresponding to a location of the graphic 4, is translucent, transparent, or clear, with a visible light transmittance (VLT) of at least 20%, so that the graphic 4 can be seen by a user through at least one of the first layer 2 and the second layer 3. Preferably, at least a portion of the first layer 2, corresponding to a location of the graphic 4, is translucent or clear so that the graphic 4 can be seen through the first layer 2. More preferably, at least a portion, if not all, of the first layer 2 is clear.

For example, at least a portion, if not all, of the first layer 2 may have a VLT of at least 20%, preferably at least 50%, more preferably at least 80%, more preferably still at least 90%, and most preferably 100%. Similarly, at least a portion, if not all, of the second layer 3 may have a VLT of at least 20%, preferably at least 50%, more preferably at least 80%, more preferably still at least 90%, and most preferably 100%.

It is noted that the terminology used above is for the purpose of reference only, and is not intended to be limiting. For example, terms such as “upper”, “lower”, “above”, “below”, “rightward”, “leftward”, “clockwise”, and “counterclockwise” refer to directions in the drawings to which reference is made. As another example, terms such as “inward” and “outward” may refer to directions toward and away from, respectively, the geometric center of the component described. As a further example, terms such as “front”, “rear”, “side”, “leftside”, “rightside”, “top”, “bottom”, “horizontal”, and “vertical” describe the orientation of portions of the component within a consistent but arbitrary frame of reference which is made clear by reference to the text and the associated drawings describing the component under discussion. Such terminology will include the words specifically mentioned above, derivatives thereof, and words of similar import.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

In addition, it is noted that citation or identification of any document in this application is not an admission that such document is available as prior art to the present invention.

1. A case for a mobile device, comprising:
a first layer;
a second layer arranged to be located closer to the mobile device than the first layer when the mobile device is arranged within the case; and
a first graphic that is located between the first layer and the second layer;
wherein a first portion of at least one layer, of the first and second layers, corresponding to a location of the first graphic within the case, is translucent, transparent, or clear.

2. The case according to one of claims 1;
wherein the first portion is a portion of the first layer.

3. The case according to one of claims 1;
wherein the first portion is a portion of the second layer.

4. The case according to claim 1;
wherein first portions of both the first and second layers, each first portion corresponding to a location of the first graphic within the case, are translucent, transparent, or clear,

5. The case according to claim 1;
wherein each first portion is translucent.

6. The case according to claim 1;
wherein each first portion is transparent.

7. The case according to claim 1;
wherein each first portion is clear.

8-12. (canceled)

13. The case according to claim 1;
wherein the first layer and the second layer are permanently affixed to each other.

14. The case according to claim 1;
wherein the first layer mechanically engages with the second layer so as to be separable therefrom.

15. The case according to claim 1;
wherein the first layer comprises a rigid material; and
wherein the second layer comprises an elastomeric material.

16-17. (canceled)

18. The case according to claim 1;
wherein the first graphic is permanently affixed to an inside surface of the first layer, which inside surface faces toward the mobile device when the mobile device is arranged in the case.

19. The case according to claim 18, further comprising:
a second graphic that is permanently affixed to an outside surface of the second layer, which outside surface faces away from the mobile device when the mobile device is arranged in the case.

20. The case according to claim 1;
wherein the first graphic is permanently affixed to an outside surface of the second layer, which outside surface faces away from the mobile device when the mobile device is arranged in the case.

21. A method of forming a case for a mobile device, comprising:
molding a first layer;
printing a first graphic on the first layer;
molding a second layer; and
joining the first layer and the second layer together so that the first graphic is located between the first and second layers.

22. The method according to claim 21;
wherein the second layer is molded separately from, and before, after, or simultaneously with, the first layer.

23. The method according to claim 22, further comprising:
printing a second graphic on the second layer before the first and second layers are joined together;
wherein the first layer and the second layer are joined together so that both the first graphic and the second graphic are located between the first and second layers.

24. (canceled)

25. The method according to claim 21;
wherein the first graphic is printed on an inside surface of the first layer, which inside surface faces toward the mobile device when the mobile device is arranged in the case; and
wherein molding the second layer, and joining the first layer and the second layer, jointly comprise:
placing the first layer into an overmold tool, and molding the second layer onto the inner surface of the first layer so as to cover the printed graphic and join the second layer to the first layer.

26. The method according to claim 21;
wherein the first layer comprises a rigid material; and
wherein the second layer comprises an elastomeric material.

27. The method according to claim 21;
wherein the first graphic is printed on an outside surface of the first layer, which outside surface faces away from the mobile device when the mobile device is arranged in the case; and
wherein molding the second layer, and joining the first layer and the second layer, jointly comprise:
placing the first layer into an overmold tool, and molding the second layer onto the outside surface of the first layer so as to cover the printed graphic and join the second layer to the first layer.

28. The method according to claim 21;
wherein a first portion of at least one layer, of the first and second layers, corresponding to a location of the first graphic within the case, is translucent, transparent, or clear.

29-31. (canceled)
